(19) United States
(12) Patent Application Publication
(10) Pub. No.: US 2005/0170811 A1
(43) Pub. Date: Aug. 4, 2005

(54) Protected mode for mobile communications terminals

(76) Inventors: Mariana Benitez Pelaez, Naperville, IL (US); Victoria Marie Halsell, Aurora, IL (US); Kamal K. Verma, Darien, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/772,184

(22) Filed: Feb. 4, 2004

(51) Int. Cl. H04Q 7/20

(52) U.S. Cl. 455/410; 455/417

(57) ABSTRACT

A method for preventing unauthorized use of a lost or stolen mobile communications terminal is provided. The method includes placing the mobile communications terminal in a Protected Mode without deactivating the mobile communications terminal's terminal identifier, preventing outgoing calls from being made from the mobile communications terminal while it is in the Protected Mode, and redirecting incoming calls destined for the mobile communications terminal while it is in the Protected Mode. A system for protecting the lost or stolen mobile communications terminal from unauthorized use includes a mobile communications terminal having a terminal identifier and a Protected Mode for preventing unauthorized use without deactivation of the terminal identifier.

The present invention relates to telecommunications, and more particularly to wireless mobile telecommunications terminals that are lost or stolen.

Mobile communications terminals can include phones, also known as cellular phones or mobile phones, and other mobile terminals which can provide communication over a mobile communications network also known as a cellular network. Mobile communications terminals, are often small and thus, they can be easily misplaced. These terminals can also be stolen.

Currently when a user has misplaced a mobile terminal, or it has been stolen, the user must call the mobile communications service provider to have the terminal deactivated to prevent misuse, such as unauthorized used by others. Once the terminal is deactivated, calls cannot be made from the terminal, and incoming calls usually receive a “disconnected” announcement from the network.

Mobile terminals include a terminal identifier known as an Electronic Serial Number (ESN) which is used by the network to identify the terminal during communications over the network. Typically, deactivating a lost or stolen mobile terminal is accomplished by deactivating the terminal's terminal identifier. However, deactivating the terminal identifier, prevents incoming calls destined for the terminal from being forwarded to the subscriber's Voice Mail System or another phone number associated with that terminal. Thus the user is left without a way for incoming callers to reach them, even using voicemail, call forwarding, etc.

It is desirable to provide a system and method for a lost or stolen mobile communications terminal to continue to operate with limited functionality while preventing unauthorized use by others until the device has been recovered or replaced.

### SUMMARY OF THE INVENTION

In accordance with a first aspect of the invention, a method preventing unauthorized use of a lost or stolen mobile communications terminal is provided. The method includes placing the mobile communications terminal in a Protected Mode without deactivating the mobile communications terminal's terminal identifier, preventing outgoing calls from being made from the terminal while it is in the Protected Mode, and redirecting incoming calls destined for the terminal while it is in the Protected Mode.

In accordance with another aspect of the invention, a system for protecting a lost or stolen mobile communications terminal from unauthorized use is provided. The system includes a mobile communications terminal having a terminal identifier and a Protected Mode for preventing unauthorized use without deactivation of the terminal identifier, means for preventing outgoing calls from being made from the mobile communications terminal while in the Protected Mode, and means for redirecting incoming calls destined for the mobile communications terminal while in the Protected Mode.

### BRIEF DESCRIPTION OF THE DRAWINGS

The invention may take form in certain components and structures, preferred embodiments of which will be illustrated in the accompanying drawings wherein:

FIG. 1 is a block diagram illustrating the invention;

FIG. 2 is a flow chart illustrating steps of the invention;

FIG. 3 is a block diagram illustrating the subscriber activating the Protected Mode in accordance with the invention;

FIG. 4 is a message flow diagram illustrating the subscriber activating the Protected Mode in accordance with the invention;

FIG. 5 is a block diagram illustrating the service provider activating the Protected Mode in accordance with the invention;

FIG. 6 is a message flow diagram illustrating the service provider activating the Protected Mode in accordance with the invention;

FIG. 7 illustrates the Protected Mode in accordance with the invention;

FIG. 8 is a message flow diagram illustrating the redirecting of incoming calls destined for the lost or stolen mobile terminal while it is in Protected Mode in accordance with the invention; and

FIG. 9 is a message flow diagram illustrating the prevention of outgoing calls attempted to be made from the lost or stolen mobile terminal while the terminal is in Protected Mode in accordance with the invention.

### DETAILED DESCRIPTION OF THE INVENTION

Referring to FIG. 1, a portion of a mobile communications network is shown generally at 10. The mobile communications network 10 can be any suitable known mobile communications network including but not limited to CDMA, GSM, etc. A mobile communications network provider, also know as the service provider (not shown), provides the services of the mobile communications network 10 to subscribers. A subscriber can communicate over the mobile communications network 10 using a mobile communications terminal 12. The mobile communications terminal 12, can be capable of sending and/or receiving various media such as data, text, special applications, video, etc., as well as provide voice communications. Examples can include, but are not limited to, CDMA, 3GPP and 3GPP2 terminals, or any other mobile communications terminals capable of providing communications over the mobile communications network 10.

The mobile communications network 10 includes a base station 14 communicating with the mobile communications terminal 12 over an air interface 16. The mobile communications network 10 also includes one or more Call Session Managers (CSM) 18 which can be any one or more wireless network elements capable of handling at least a portion of the call sessions. The CSM 18 can handle at least a portion of functions which can include, but is not limited to, call set-ups, registration and call routing to/from the mobile communications terminal 12. Examples of the CSM 18 can include, but are not limited to, an Internet Protocol Multimedia Subsystem (IMS) for 3GPP and 3GPP2 wireless networks, and a Mobile Switching Center (MSC) for CDMA wireless networks.

The Call Session Manager 18 can be connected to the base station 14 via a bearer path also known as a bearer channel, shown as dashed line 20. The bearer path is set up during conventional calls between the terminal 12 and other terminals, one of which is shown at 12a, to carry communications traffic, including voice and/or data communications, allowing users to communicate with each other using the terminals 12 and 12a. Examples of the other terminals 12a can include, but are not limited to, other mobile communications terminals, Public Switched Telephone Network terminals, Voice over Internet Protocol terminals, or other terminals capable of communicating over the bearer path 20 with the mobile terminal 12.

The Call Session Manager 18 is also connected to the base station 14 via a control path, also known as a control channel, shown as solid line 22. The control path 22 carries system signaling such as control messages between the mobile terminal 12 and other appropriate network elements, and between the network elements themselves, such that call sessions are properly setup, managed and routed. Suitably, Session Initiated Protocol (SIP) and/or other appropriate known protocols are used on the control and bearer paths, one example of which should not be limiting is the known H.248 protocol.

The mobile communications network 10 also includes a Home Location Register (HLR) 24 for storing control and/or call state information for the mobile terminal 12, such as network access control information for authentication and authorization, and terminal location information for registration and locating. The HLR 24 also stores subscription services information pertaining to the subscriber. This information can be associated with each mobile terminal 12 using the terminal's mobile identity number (MIN) or in any other known manner. The HLR 24 can be a Home Subscriber Server.

The mobile communications network 10 also includes a Protected Mode Application Server (PMAS) 26 connected to the CSM at 28 using known connections for transferring control messages therebetween. The PMAS 26 is responsible for associated application processing for activating and deactivating the Protected Mode. The PMAS 26 can stand apart from the CSM 18 or it can be part of the CSM.

The mobile communications network 10 also includes a Voice Mail System 30 connected to the CSM at 28 using known connections. Incoming calls destined for the terminal 12 can be directed to the Voice Mail System 30 so that the caller making the incoming call can leave a message for the subscriber. The subscriber can access the messages in a known manner.

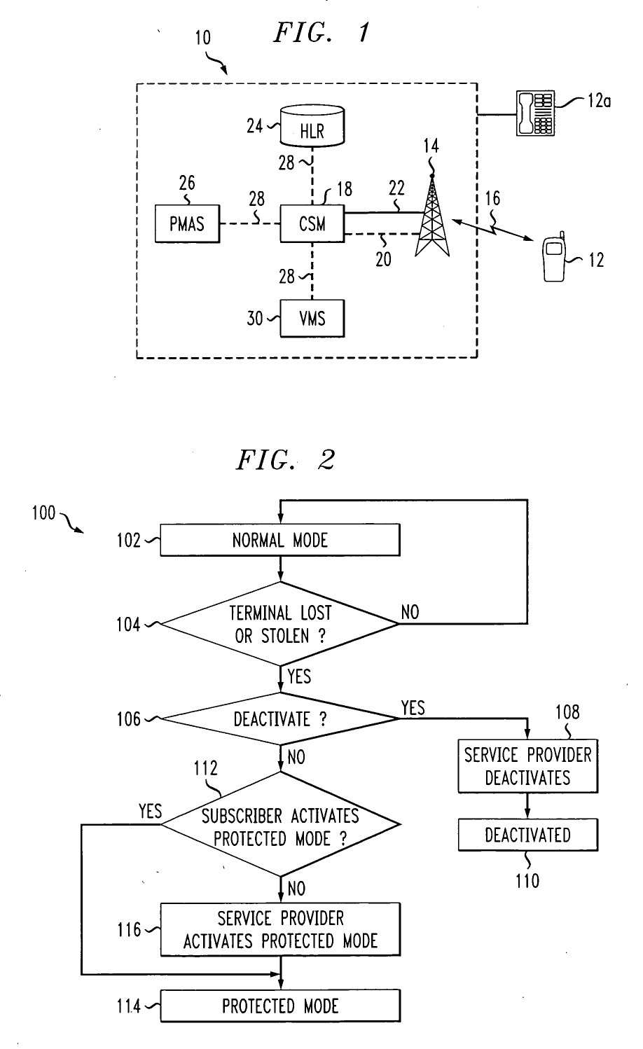

Referring to FIG. 2, the invention includes a method for protecting a lost or stolen mobile communications terminal 12 from unauthorized use shown generally at 100. Typically, the terminal 12 is in normal mode as shown at 102. In normal mode, the terminal 12 is capable of making outgoing calls and receiving incoming calls. The terminal 12 typically remains in normal mode when it is not lost or stolen.

When the terminal 12 is lost or stolen at 104 a decision can be made whether to deactivate the terminal 12 at 106. If it is decided to deactivate the terminal 12, the subscriber notifies the service provider that the terminal is lost or stolen and the service provider deactivates the terminal at 108 in a known manner, such as by deactivating the terminal identifier, such as the Electronic Serial Number. Deactivating the terminal identifier prevents unauthorized use of the terminal 12 since once deactivated, outgoing calls cannot be made from the terminal and incoming calls usually receive a “disconnected” message from the network 10.

In accordance with the invention, placing the terminal in a Protected Mode 114 provides an alternative to deactivating the lost or stolen terminal's terminal identifier. The subscriber can place the terminal 12 in the Protected Mode 114 at 112.

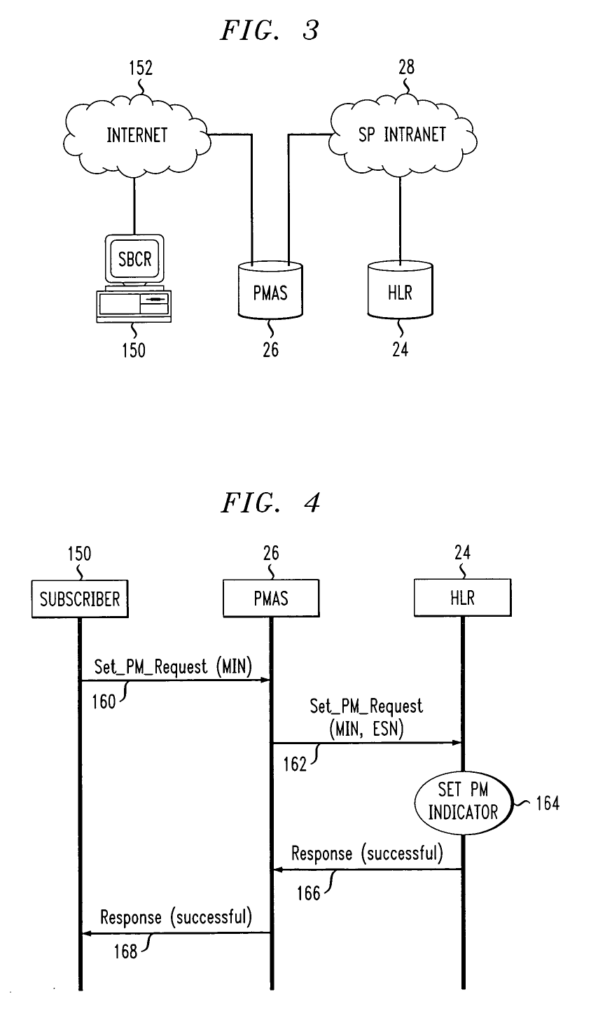

Referring to FIGS. 3 and 4, the subscriber can activate the Protected Mode using any suitable electronic device, including but not limited to a computer shown at 150, connected to the PMAS 26 via the Internet 152. The subscriber logs on to the service provider webpage entering a password, Personal Identification Number (PIN), etc. which then associates the subscriber generated command messages with the terminal 12, such as for example by including the terminal's Mobile Identity Number (MIN). The subscriber requests that the terminal 12 be placed in Protected Mode sending a Set_PM_Request message to the PMAS 26 at 160. The PMAS 26 sends a Set_PM_Request message including the MIN and the Electronic Serial Number for the mobile terminal to the HLR 24 at 162.

The HLR 24 verifies whether the subscriber subscribes to the Protected Mode feature and whether the subscriber is authorized to set the Protected Mode. Upon verification, the HLR 24 sets a Protected Mode (PM) indicator at 164. The PM indicator can be a flag or any other suitable indicator for indicating that Protected Mode has been activated for the terminal/subscriber 12. The HLR 24 sends a response at 166 to the PMAS over the service provider network connection 28 notifying that PM has been successfully set. The PMAS 26 sends a response over the Internet 152 to the subscriber at 168 that Protected Mode has been set.

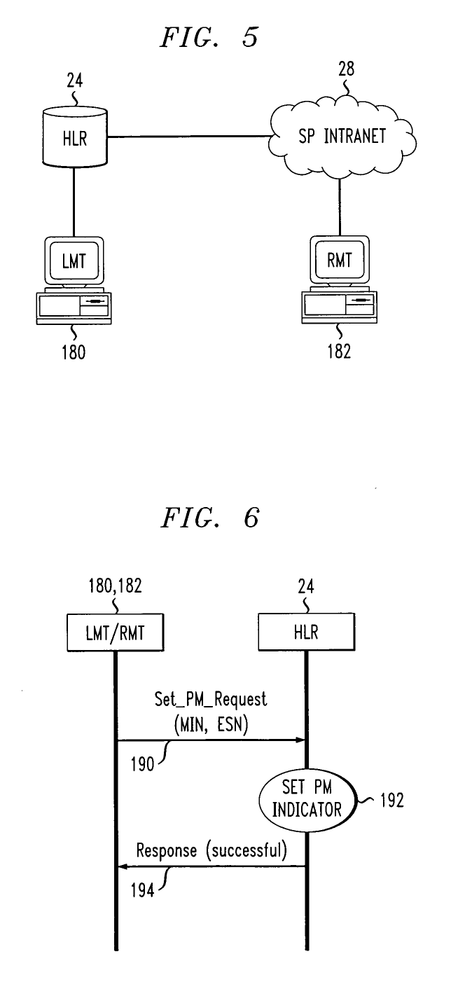

Alternatively, the subscriber can notify the service provider that the terminal 12 has been lost or stolen and the service provider can activate the Protected Mode 114 at 116 in FIG. 2. Referring to FIGS. 5 and 6, Protected Mode control command messages can be sent to the HLR 24 by the service provider using a Local Maintenance Terminal computer 180, or using a Remote Maintenance Terminal computer 182 connected to the HLR 24 via the service provider network 28. Referring to the message flow diagram shown in FIG. 6 a Set_PM_Request message is sent to the HLR 24 at 190. The Set_PM_Request message includes the mobile terminal's identifier, such as the MIN, and the mobile terminal's ESN. The HLR 24 verifies that the subscriber subscribes to the PM feature and sets the PM indicator at 192. The HLR 24 then sends a response at 194 to the LMT/RMT 180, 182 indicating that the PM has been set for the terminal 12.

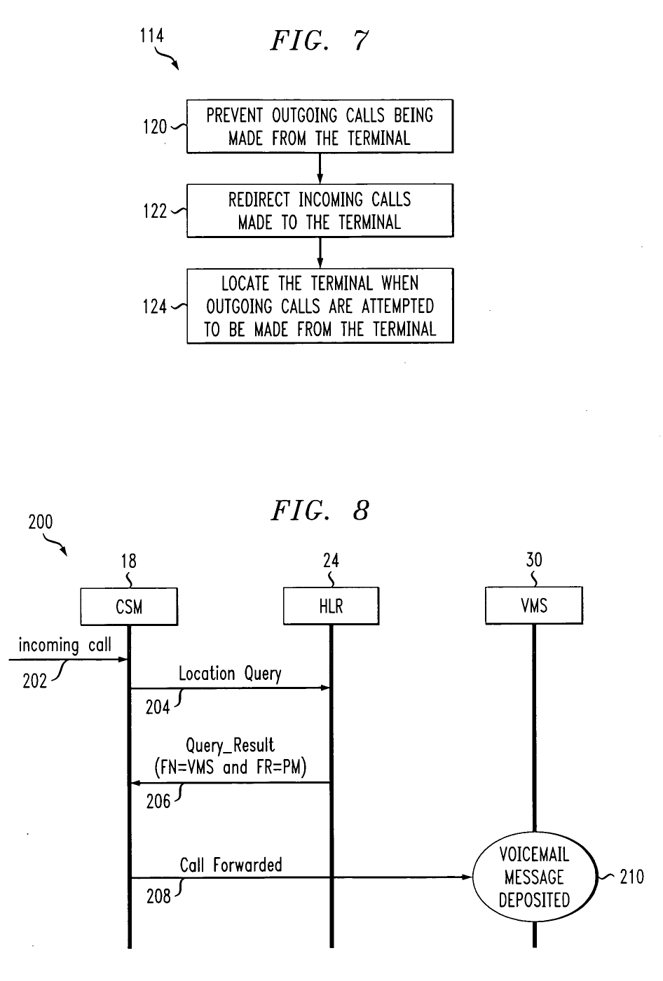

Referring now to FIG. 7, the Protected Mode 114 includes preventing outgoing calls from being made from the terminal at 120 and redirects incoming calls made to the terminal at 122. Further, the PMAS 26 can direct the network 10 to locate the terminal 12 at 124 when outgoing calls are attempted to be made from the terminal using any suitable known manner for locating a mobile terminal.

Referring to FIG. 8, message flows for incoming calls made to the terminal 12 while in Protected Mode are shown generally at 200. An incoming call to the terminal 12 while the terminal is in Protected Mode generates incoming call signaling during call setup that is sent to the CSM 14 at 202. Examples of the signaling protocol can include, but are not limited to, SIP, ISUP or BICC among others.

The CSM 14 queries the HLR 24 sending a Location_Query at 204 to locate the mobile terminal 12 and identify user preferences or feature sets that may need to be invoked for the call. The Location_Query message at 204 is used here for the purposes of example and should not be considered limiting. Other suitable signaling messages including, but are not limited to, GSM, MAP, ANSI 41 among others can be used for locating the terminal and identifying user preferences or features that are needed to invoke the call.

The HLR 24 verifies that the Protected Mode indicator for the terminal 12 has been set indicating that the terminal 12 is in Protected Mode. The HLR 24 returns a Query_Result message to the CSM 18 at 206 indicating that the terminal is in Protected Mode and that the call is to be forwarded. The Query_Result message 206 can include information indicating the Forwarding Reason, that is, that incoming calls are to be forwarded because the terminal 12 is in Protected Mode, as indicated by FR=PM. The HLR 24 includes a Forwarding Number (FN) associated with the terminal 12. The Forwarding Number can be the number used to forward incoming calls to the Voice Mail Service 30 for the terminal 12 as indicated in FIG. 8 by FN=VMS. Alternatively, the Forwarding Number can be the number used to forward the incoming calls to another terminal 12b, examples of which are described above. The Query_Result message at 206 is used here for the purposes of example and should not be considered limiting. Other suitable signaling messages can be used including, but not limited to, GSM, MAP, ANSI 41 among others can be used for acknowledging the Location_Query message at 204 above and providing the Forwarding Reason and/or Forwarding Number information for forwarding the call when the terminal 12 is in Protected Mode.

Receiving the Query_Result message, the CSM 18 forwards the incoming call 102 to the terminal's Voice Mail System 30 at 208. The caller making the incoming call 102 can deposit a voicemail message in the Voice Mail System 30 as shown at 210. Alternatively, the CSM forwards the incoming call 102 to another terminal 12a as indicated by the forwarding number. The invention protects the lost or stolen mobile terminal 12 without deactivating the terminal using the Protected Mode thereby allowing the subscriber to continue to receive incoming messages destined for the terminal.

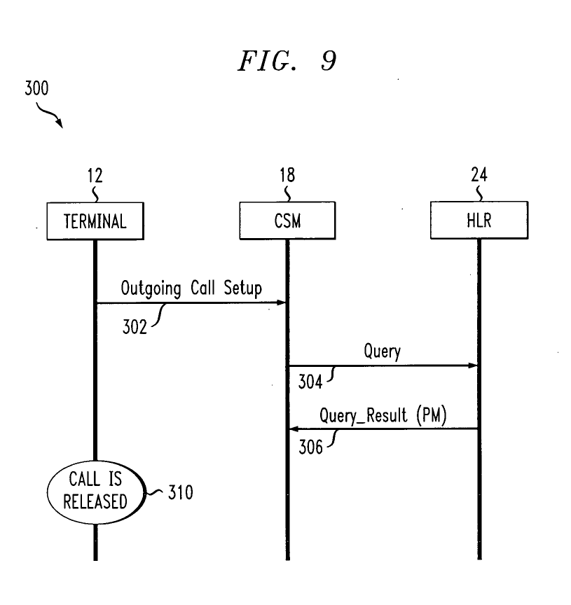

Referring to FIG. 9, a call flow diagram illustrating call control messages generated for outgoing calls attempted to be made from the mobile terminal 12 when it is in Protected Mode is shown generally at 300. When a call is attempted to be made from the terminal 12 when it is in Protected Mode an Outgoing_Call_Setup message sent from the terminal 12 to the CSM 18 as 302. An examples of the Outgoing_Call_Setup message at 206 can include, but is not limited to, an SIP Invite message, ISUP Initial Address Message (IAM), among others.

The CSM 18 receives the Outgoing_Call_Setup message and processes the call setup. A Query message can be sent to the HLR 24 at 304 to request call setup information for the terminal 12, including identifying user preferences or feature sets that may need to be invoked for the call. Examples of this signaling can include, but are not limited to GSM, MAP, ANSI 41 signaling.

The HLR 24 receives the Query Message and verifies that the Protected Mode indicator for the terminal 12 has been set indicating that the terminal 12 is in Protected Mode. The HLR 24 returns a Query_Result message back to the CSM 18 at 306 indicating that the terminal 12 is in Protected Mode. Alternatively, the subscriber information indicating that the terminal 12 is in Protected Mode can be cached on the CSM 18 and the Query message 304 and Query_Result message at 306 are not be used.

The CSM 18 determines that the terminal 12 is in Protected Mode because the Protected Mode indicator is set. The CSM 18 releases the call at 310, thereby preventing the outgoing call from being made by the terminal while it is in Protected Mode. This prevents unauthorized use of the terminal 12 while it is lost or stolen and in Protected Mode without deactivating the terminal identifier. The CSM 18 can optionally locate the terminal 12 when an outgoing call is attempted to be made using any suitable known means for locating a mobile communications terminal. The location information can be used by the subscriber, the service provider and even law enforcement to find the lost or stolen mobile communications terminal.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

1. A method of protecting a lost or stolen mobile communications terminal having a terminal identifier from unauthorized use comprising:
placing the mobile communications terminal in a Protected Mode without deactivating the mobile communications terminal's terminal identifier;
preventing outgoing calls from being made from the mobile communications terminal in the Protected Mode; and
redirecting incoming calls destined for the mobile communications terminal in the Protected Mode.

2. The method defined in claim 1 wherein the identifier is an Electronic Serial Number (ESN).

3. The method defined in claim 1 wherein the redirecting step includes redirecting the incoming calls to the mobile communications terminal's voicemail system.

4. The method defined in claim 1 wherein the redirecting step includes redirecting the incoming calls to a forwarding number.

5. The method defined in claim 1 wherein the placing step includes the subscriber placing the terminal in the Protected Mode.

6. The method defined in claim 1 wherein the placing step includes the subscriber placing the terminal in the Protected Mode using a web site.

7. The method defined in claim 1 wherein the placing step includes the mobile communications service provider placing the terminal in the Protected Mode.

8. The method defined in claim 1 further comprising locating the terminal when a call is attempted to be made from the mobile terminal in Protected Mode.

9. A system for protecting a lost or stolen mobile communications terminal having a terminal identifier from unauthorized use comprising:
a mobile communications terminal having a terminal identifier and a Protected Mode for preventing unauthorized use without deactivation of the terminal identifier;
means for preventing outgoing calls from being made from the mobile communications terminal while in the Protected Mode; and
means for redirecting incoming calls destined for the mobile communications terminal while in the Protected Mode.

10. The system defined in claim 9 wherein the means for redirecting incoming calls includes means for redirecting incoming calls to the Voice Mail System of the mobile communications terminal.

11. The system defined in claim 9 wherein the means for redirecting incoming calls includes means for redirecting incoming calls to another terminal.

12. The system defined in claim 9 wherein the means for preventing outgoing calls from being made from the mobile communications terminal includes a Call Session Manager.

13. The system defined in claim 12 wherein the Call Session Manager is a Mobile Switching Center.

14. The system defined in claim 12 wherein the Call Session Manager is an Internet Protocol Multimedia Subsystem.
